(19) United States
(12) Patent Application Publication
(10) Pub. No.: US 2013/0106041 A1
(43) Pub. Date: May 2, 2013

(54) SUBSTRATE PROCESSING APPARATUS, TABLE MECHANISM, POSITIONING METHOD, AND PROGRAM

(71) Applicant: Sony Corporation, Tokyo (JP)

(72) Inventor: Tsutomu Noda, Saitama (JP)

(73) Assignee: Sony Corporation, Tokyo (JP)

(21) Appl. No.: 13/658,842

(22) Filed: Oct. 24, 2012

(30) Foreign Application Priority Data
Oct. 31, 2011 (JP) 2011-239658

(51) Int. Cl. B23Q 16/00; B23Q 1/26

(52) U.S. Cl. 269/58; 29/407.04

(57) ABSTRACT

A substrate processing apparatus includes a table, an eccentric cam mechanism, a reference mark, an imaging unit, and a controller. The table is for positioning a substrate. The eccentric cam mechanism includes an eccentric cam configured to move the table by a rotation. The reference mark moves in accordance with a movement of the table. The imaging unit is configured to image the reference mark. The controller is configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

### BACKGROUND

The present disclosure relates to the technology including a substrate processing apparatus such as a screen printing apparatus, a positioning mechanism used for a substrate processing apparatus, and the like.

From the past, a screen printing apparatus that prints a solder paste onto a substrate has been widely used (see, for example, Japanese Patent Application Laid-open Nos. 2010-234627 and 2007-237668).

The screen printing apparatus includes a squeegee and a substrate, the squeegee being disposed above a screen provided with patterned holes, the substrate being disposed below the screen. A solder paste is supplied onto the screen, and the squeegee is caused to slide on the screen. When the squeegee slides on the screen, the solder paste is printed onto the substrate, which is disposed below the patterned holes.

The substrate disposed below the screen is held by a stage. The stage is supported by a positioning mechanism including an X-axis table, a Y-axis table, a θ-axis table, and the like. This positioning mechanism allows the substrate held by the stage to be positioned with respect to the screen. The X-axis table, the Y-axis table, the θ-axis table, and the like are generally driven by use of a ball screw and a motor configured to rotate the ball screw.

### SUMMARY

In the case where the X-, Y-, and θ-axis tables are driven by use of the ball screw and the motor, the positioning accuracy of the substrate with respect to the screen depends on the machining accuracy of the ball screw and the accuracy of an encoder that detects a rotation of the motor. In recent years, the performance of the encoder of the motor is being improved, but the precision machining of the ball screw is still expensive.

In view of the circumstances as described above, it is desirable to provide the technology including a substrate processing apparatus and the like that are capable of reducing costs and precisely positioning a substrate.

According to an embodiment of the present disclosure, there is provided a substrate processing apparatus including a table, an eccentric cam mechanism, a reference mark, an imaging unit, and a controller.

The table is for positioning a substrate.

The eccentric cam mechanism includes an eccentric cam configured to move the table by a rotation.

The reference mark moves in accordance with a movement of the table.

The imaging unit is configured to image the reference mark.

The controller is configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

In the substrate processing apparatus, since the eccentric cam mechanism including the eccentric cam as a mechanism for moving the table is used, costs are reduced as compared to a table drive mechanism using a ball screw and the like. Further, in this embodiment, the reference mark moving in accordance with the rotation of the eccentric cam is imaged by the imaging unit so that a movement amount of the table with respect to the rotation of the eccentric cam is measured. As a result, the substrate is precisely positioned by the rotation of the eccentric cam at a time of positioning the substrate.

The substrate processing apparatus may further include a sensor configured to detect a temporary center of a cam stroke of the eccentric cam.

In this case, the controller may rotate the eccentric cam from a state where the eccentric cam is located at the temporary center of the cam stroke and image a reference mark moving in accordance with the rotation of the eccentric cam by the imaging unit, to thereby measure an actual center of the cam stroke of the eccentric cam.

Since the substrate processing apparatus includes the sensor configured to detect a temporary center of a cam stroke of the eccentric cam, even if the substrate processing apparatus does not yet recognize the center of the cam stroke (for example, at a time of power-on), the substrate processing apparatus recognizes an approximate center of the cam stroke of the eccentric cam. Then, the substrate processing apparatus rotates the eccentric cam from the state where the eccentric cam is located at the approximate center of the cam stroke (temporary center of cam stroke) and images the reference mark by the imaging unit so that an actual center of the cam stroke of the eccentric cam is measured. Thus, the actual center of the cam stroke of the eccentric cam is precisely measured.

In the substrate processing apparatus, the controller may rotate the eccentric cam from a state where the eccentric cam is located at an actual center of the cam stroke of the eccentric cam and image a reference mark moving in accordance with the rotation of the eccentric cam by the imaging unit, to thereby measure a movement amount of the table with respect to the rotation of the eccentric cam.

With this structure, since the eccentric cam is rotated from the state where the eccentric cam is located at the actual center of the cam stroke of the eccentric cam to move the reference mark, the movement amount of the table with respect to the rotation of the eccentric cam is precisely measured.

The substrate processing apparatus may further include a movement mechanism for moving the imaging unit.

In this case, the controller may move, in the state where the eccentric cam is located at the temporary center of the cam stroke, the imaging unit by the movement mechanism such that the reference mark is located at a center of an imaging field of the imaging unit, rotate the eccentric cam after the imaging unit is moved, and image a reference mark moving in accordance with the rotation of the eccentric cam by the imaging unit, to thereby measure the actual center of the cam stroke of the eccentric cam.

In the substrate processing apparatus, the imaging unit is moved such that the reference mark is located at the center of the imaging field of the imaging unit in the state where the eccentric cam is located at the temporary center of the cam stroke. After that, the reference mark that moves in accordance with the rotation of the eccentric cam is imaged. Thus, the position of the reference mark is prevented from being mismeasured due to a lens distortion or the like of the imaging unit. As a result, the actual center of the cam stroke is more precisely measured.

In the case where the substrate processing apparatus further includes a movement mechanism for moving the imaging unit, the controller may move, in the state where the eccentric cam is located at the actual center of the cam stroke, the imaging unit by the movement mechanism such that the reference mark is located at a center of an imaging field of the imaging unit, rotate the eccentric cam after the imaging unit is moved, and image a reference mark moving in accordance with the rotation of the eccentric cam by the imaging unit, to thereby measure the movement amount of the table with respect to the rotation of the eccentric cam.

In the substrate processing apparatus, the imaging unit is moved such that the reference mark is located at the center of the imaging field of the imaging unit in a state where the eccentric cam is located at the actual center of the cam stroke. After that, the reference mark that moves in accordance with the rotation of the eccentric cam is imaged. Thus, the position of the reference mark is prevented from being mismeasured due to a lens distortion or the like of the imaging unit. As a result, the movement amount of the table with respect to the rotation of the eccentric cam is more precisely measured.

In the substrate processing apparatus, the eccentric cam mechanism may include the eccentric cam formed of a magnetic body, and a cam bearing block including a magnet.

With such a mechanism, the eccentric cam and the cam bearing block are attracted to each other. Thus, the stage moved in one direction by the rotation of the eccentric cam is returned to the opposite direction.

In the substrate processing apparatus, the substrate may include an alignment mark.

In this case, the substrate processing apparatus may further include an imaging unit configured to image the alignment mark provided on the substrate.

In this case, the imaging unit configured to image the alignment mark may be used as the imaging unit configured to image the reference mark.

The substrate processing apparatus such as a screen printing apparatus generally includes the imaging unit configured to image an alignment mark provided on the substrate. In this substrate processing apparatus, the imaging unit configured to image the alignment mark on the substrate is used as the imaging unit configured to image the reference mark. Thus, since the existing imaging unit (imaging unit for imaging alignment mark on substrate) is used as the imaging unit for imaging the reference mark, it is not necessary to especially provide the imaging unit for imaging a reference mark to the substrate processing apparatus. Therefore, costs are more reduced.

In the substrate processing apparatus, the eccentric cam may have a substantially cylindrical shape.

As described above, since the reference mark that moves in accordance with the rotation of the eccentric cam is imaged by the imaging unit to measure the movement amount of the table with respect to the rotation of the eccentric cam in the embodiment of the present disclosure, it is not necessary to make the shape of the eccentric cam complicated. In other words, even if the eccentric cam has a simple shape such as a substantially cylindrical shape (simple shape in which a cam curve and the like are not taken into consideration), the movement amount of the table with respect to the rotation of the eccentric cam is precisely measured. Then, the eccentric cam formed into a substantially cylindrical shape allows that costs to be further reduced.

According to another embodiment of the present disclosure, there is provided a table mechanism including a table, an eccentric cam mechanism, a reference mark, an imaging unit, and a controller.

The table is for positioning a substrate.

The eccentric cam mechanism includes an eccentric cam configured to move the table by a rotation.

The reference mark moves in accordance with a movement of the table.

The imaging unit is configured to image the reference mark.

The controller is configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

According to another embodiment of the present disclosure, there is provided a positioning method, including: rotating an eccentric cam configured to move by a rotation a table for positioning a substrate to move the table; imaging, by an imaging unit, a reference mark moving in accordance with the movement of the table to measure a movement amount of the table with respect to the rotation of the eccentric cam; and rotating the eccentric cam in accordance with the measured movement amount to position the substrate at a time of positioning the substrate.

According to another embodiment of the present disclosure, there is provided a program causing a substrate processing apparatus to execute: rotating an eccentric cam configured to move by a rotation a table for positioning a substrate to move the table; imaging, by an imaging unit, a reference mark moving in accordance with the movement of the table to measure a movement amount of the table with respect to the rotation of the eccentric cam; and rotating the eccentric cam in accordance with the measured movement amount to position the substrate at a time of positioning the substrate.

As described above, according to the present disclosure, it is possible to provide the technology including a substrate processing apparatus and the like that are capable of reducing costs and precisely positioning a substrate.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a front view showing a screen printing apparatus according to an embodiment of present disclosure;

FIG. 2 is a side view showing the screen printing apparatus;

FIG. 3 is a perspective view showing a positioning mechanism;

FIG. 4 is a side view of the positioning mechanism as viewed from the A direction shown in FIG. 3;

FIG. 5 is a side view of the positioning mechanism as viewed from the B direction shown in FIG. 3;

FIG. 6 is a perspective view showing a table mechanism;

FIG. 7 is a perspective view of the table mechanism as viewed form the A direction shown in FIG. 6;

FIG. 8 is a perspective view showing an eccentric cam mechanism;

FIGS. 9A and 9B are schematic diagrams each showing a relationship between an operation of the eccentric cam and a sensor unit;

FIG. 10 is a flowchart of processing of the screen printing apparatus in a calibration sequence;

FIG. 11 is a flowchart of the processing of the screen printing apparatus in the calibration sequence;

FIG. 12 is a diagram showing a state where a reference mark is located at the center of an imaging field;

FIG. 13 is a graph showing a relationship between a trajectory of an actually-measured movement amount of a table (movement amount of reference mark) with respect to a rotation of the eccentric cam and a trajectory of the movement amount of the table (movement amount of reference mark) with respect to the rotation of the eccentric cam, the movement amount being obtained after correcting a center position;

FIG. 14 is a flowchart of a reference position registration sequence; and

FIG. 15 is a flowchart of a substrate positioning sequence.

### DETAILED DESCRIPTION OF EMBODIMENTS

Hereinafter, an embodiment of the present disclosure will be described with reference to the drawings.

[Overall Structure of Screen Printing Apparatus 100]

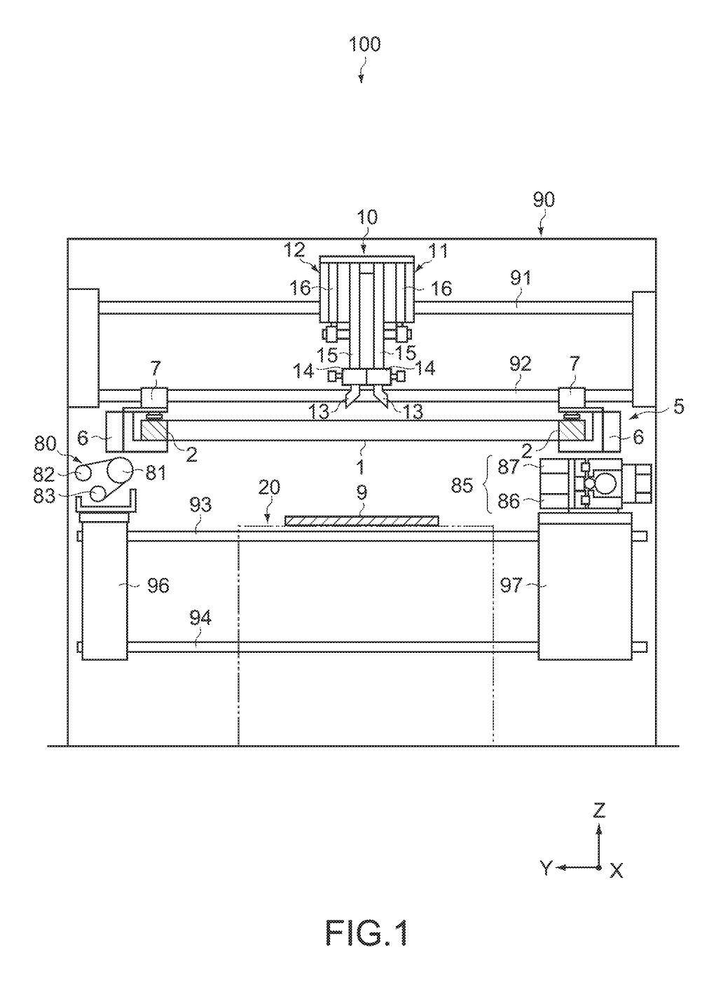

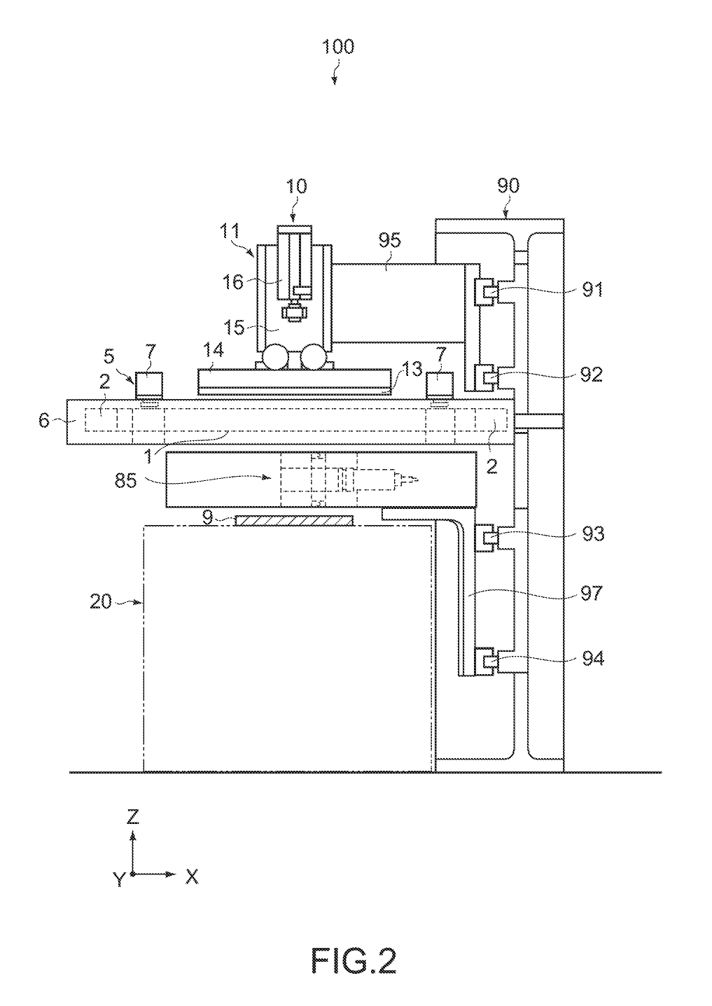

FIG. 1 is a front view showing a screen printing apparatus 100 according to this embodiment. FIG. 2 is a side view showing the screen printing apparatus 100. It should be noted that for the easy understanding of the figures described in this specification, the screen printing apparatus 100 and members and the like included in the screen printing apparatus 100 may be expressed in the size different from the actual one.

As shown in FIGS. 1 and 2, the screen printing apparatus 100 (substrate processing apparatus) includes a screen 1 and a fixing unit 5 that fixes the screen 1 to a predetermined position of the screen printing apparatus 100. Further, the screen printing apparatus 100 includes a squeegee unit 10 that is disposed above the screen 1 and slides on the screen 1 to which a solder paste is supplied.

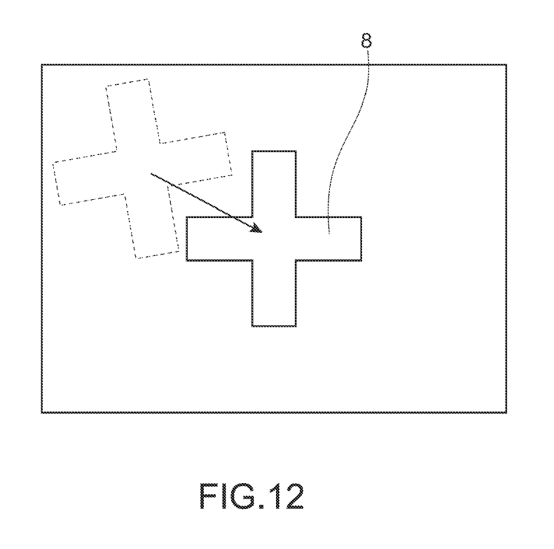

Furthermore, the screen printing apparatus 100 includes a positioning mechanism 20 disposed under the screen 1, an imaging unit 85, and a cleaning unit 80. The positioning mechanism 20 positions a substrate 9 with respect to the screen 1, the substrate 9 being a target of screen printing. The imaging unit 85 images an alignment mark provided on the substrate 9, an alignment mark provided on the lower side of the screen 1, a reference mark 8 (see FIG. 12) provided on a substrate suction stage, and the like. The cleaning unit 80 cleans a lower surface of the screen 1.

In addition, the screen printing apparatus 100 includes a support base 90 that supports, on the rear surface side of the screen printing apparatus 100, the squeegee unit 10, the cleaning unit 80, and the imaging unit 85 so as to be movable.

It should be noted that though not shown in the figures, the screen printing apparatus 100 includes a controller such as a CPU (Central Processing Unit) that performs overall control on the units of the screen printing apparatus 100. Further, the screen printing apparatus 100 includes a storage device that includes a non-volatile memory used as a work area of the controller and a non-volatile memory storing various types of programs used for the processing of the controller. The various types of programs may be read from portable recording media such as an optical disc and a semiconductor memory.

The screen 1 includes patterned holes corresponding to a wiring pattern of the substrate 9. The screen 1 is formed of metal such as stainless steel. The screen 1 is provided with a frame body 2 along the four sides of the screen 1. The frame body 2 pulls the screen 1 by a predetermined tensile force from the four directions so as not cause the slack on the screen 1.

Alignment marks for alignment with the substrate 9 are provided at two positions on the lower surface of the screen 1. Those two alignment marks are arranged, for example, at positions on a diagonal line, the positions interposing therebetween an area provided with the patterned holes. In accordance therewith, alignment marks for alignment with the screen 1 are also provided at two positions on the substrate 9. Those two alignment marks are arranged, for example, at positions on a diagonal line on the substrate 9.

The fixing unit 5 that fixes the screen 1 to a predetermined position of the screen printing apparatus 100 includes an attachment frame 6 and a plurality of screen clamps 7 that are provided to the attachment frame 6 and clamp the screen 1. The attachment frame 6 is supported by the support base 90, a support member (not shown), and the like. The screen clamps 7 sandwich the frame body 2 provided to the screen 1 in a vertical direction to fix the frame body 2.

A pair of upper guide rails 91 and 92 are provided on the upper side of the support base 90 along a Y-axis direction. Further, a pair of lower guide rails 93 and 94 are provided on the lower side of the support base 90 along the Y-axis direction.

A carriage 95 that supports the squeegee unit 10 is attached to the upper guide rails 91 and 92 so as to be movable. The squeegee unit 10 and the carriage 95 are moved along the Y-axis direction with respect to the support base 90 by, for example, the drive of a drive mechanism constituted of a ball screw, a motor, and the like.

The squeegee unit 10 includes a first squeegee mechanism 11 and a second squeegee mechanism 12 arranged symmetrically with the first squeegee mechanism 11. Each of the first squeegee mechanism 11 and the second squeegee mechanism 12 includes a squeegee 13, a squeegee holding member 14, a support member 15, and an air cylinder 16.

The squeegee 13 is moved to slide on the screen 1 to which a solder paste is supplied, to thereby apply the solder paste onto the substrate 9 through the patterned holes provided to the screen 1. The squeegee holding member 14 holds the squeegee 13, and the support member 15 supports the squeegee holding member 14. The air cylinder 16 supports the support member 15 and integrally drives the support member 15, the squeegee holding member 14, and the squeegee 13 in the vertical direction.

When one of the squeegee mechanisms is located at a lower position and moved to slide on the screen 1, the other squeegee mechanism is located at an upper position and is not in contact with the screen 1. The squeegee mechanism to slide on the screen 1 is alternately switched.

A carriage 97 that supports the imaging unit 85 and a carriage 96 that supports the cleaning unit 80 are attached to the lower guide rails 93 and 94 provided on the lower side of the support base 90 so at to be movable.

The imaging unit 85 and the carriage 97 are moved along the Y-axis direction with respect to the support base 90 by the drive of a drive mechanism constituted of a ball screw, a motor, and the like. The imaging unit 85 is attached to the carriage 97 to be movable in an X-axis direction and is moved along the X-axis direction with respect to the carriage 97 by the drive of a drive mechanism constituted of a ball screw, a motor, and the like. Thus, the imaging unit 85 is set to be movable along the Y-axis direction and the X-axis direction.

The above-mentioned guide rails 93 and 94, carriage 97, and drive mechanism for driving the imaging unit 85, and the like constitute a movement mechanism for moving the imaging unit 85.

The imaging unit 85 includes a first imaging unit 86 directed toward the lower side and a second imaging unit 87 directed toward the upper side. The first imaging unit 86 directed toward the lower side images the alignment marks provided onto the substrate 9 and the reference mark 8 (see FIG. 12) provided onto the substrate suction stage or the like. The second imaging unit 87 directed toward the upper side images the alignment marks provided on the lower surface side of the screen 1.

Each of the first imaging unit 86 and the second imaging unit 87 includes an imaging device such as a CCD (Charge Coupled Device) sensor or a CMOS (Complementary Metal Oxide Semiconductor) sensor and an optical system including an imaging lens and the like.

Although the example in which the two imaging units 86 and 87 are provided is shown in FIGS. 1 and 2, the number of imaging units to be provided may be set to one. In the case where one imaging unit is provided, the imaging unit only needs to be structured so as to be rotatable with an axis in the X-axis direction as a center axis of the rotation.

The cleaning unit 80 and the carriage 96 are moved along the Y-axis direction with respect to the support base 90 by the drive of a drive mechanism constituted of a ball screw, a motor, and the like. The cleaning unit 80 includes a roller 81, a feed roller 82 that feeds a cleaning tape, and a take-up roller 83 that takes up the cleaning tape.

When the cleaning unit 80 is moved along the Y-axis direction, in conjunction therewith, the roller 81, the feed roller 82, and the take-up roller 83 are rotated. The cleaning tape that is fed from the feed roller 82 rotates along the circumference of the roller 81 while being in contact with the lower surface of the screen 1, and then taken up by the take-up roller 83. Thus, the lower surface of the screen 1 is cleaned.

(Structure of Positioning Mechanism 20)

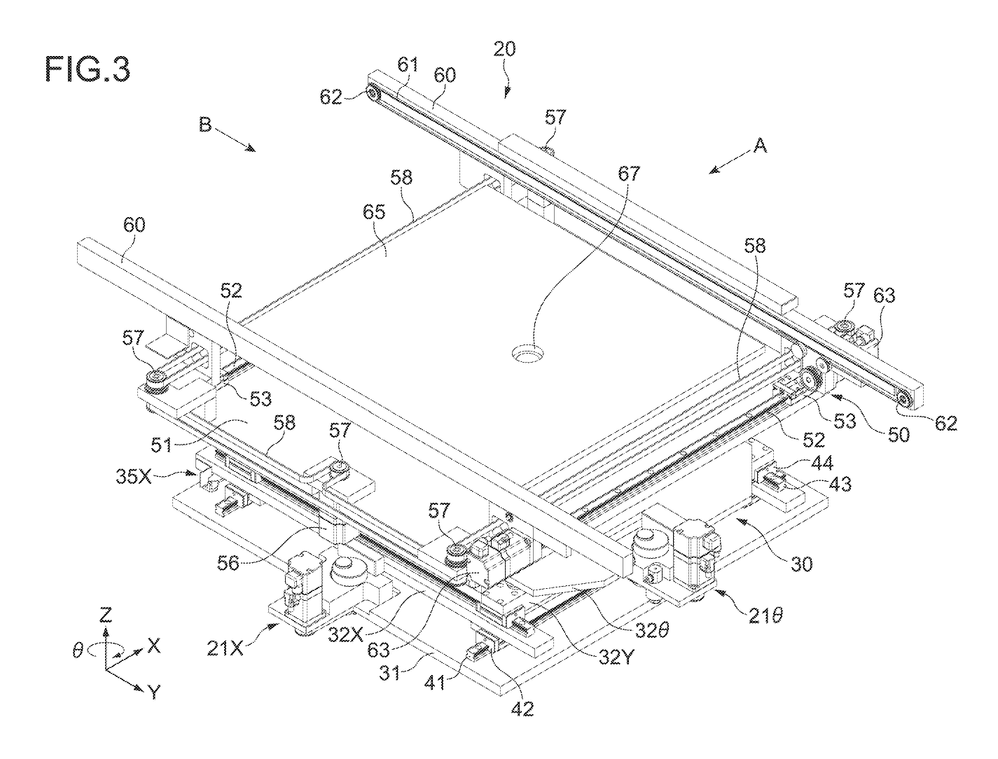

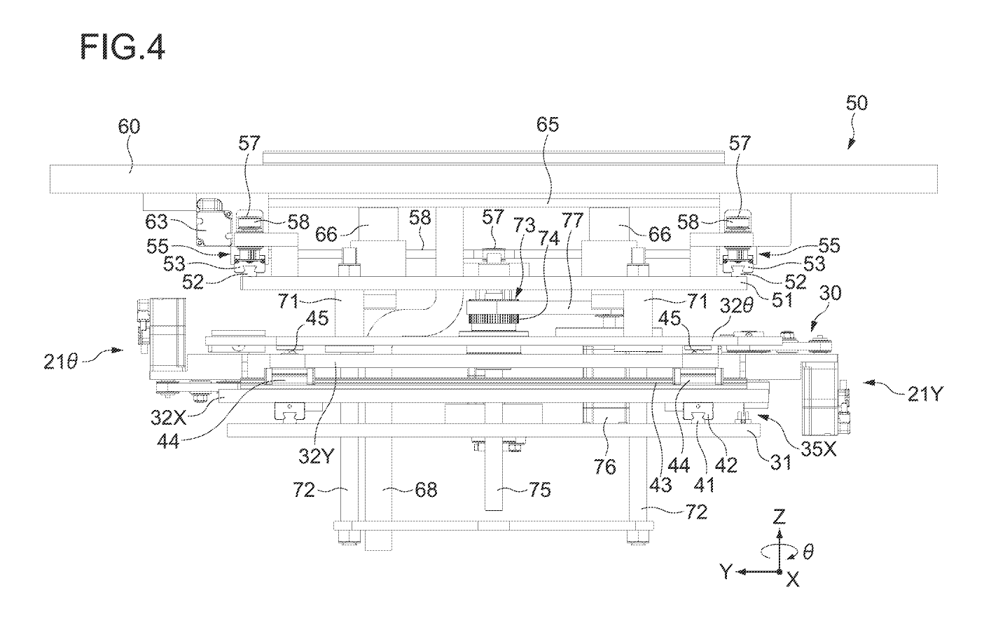

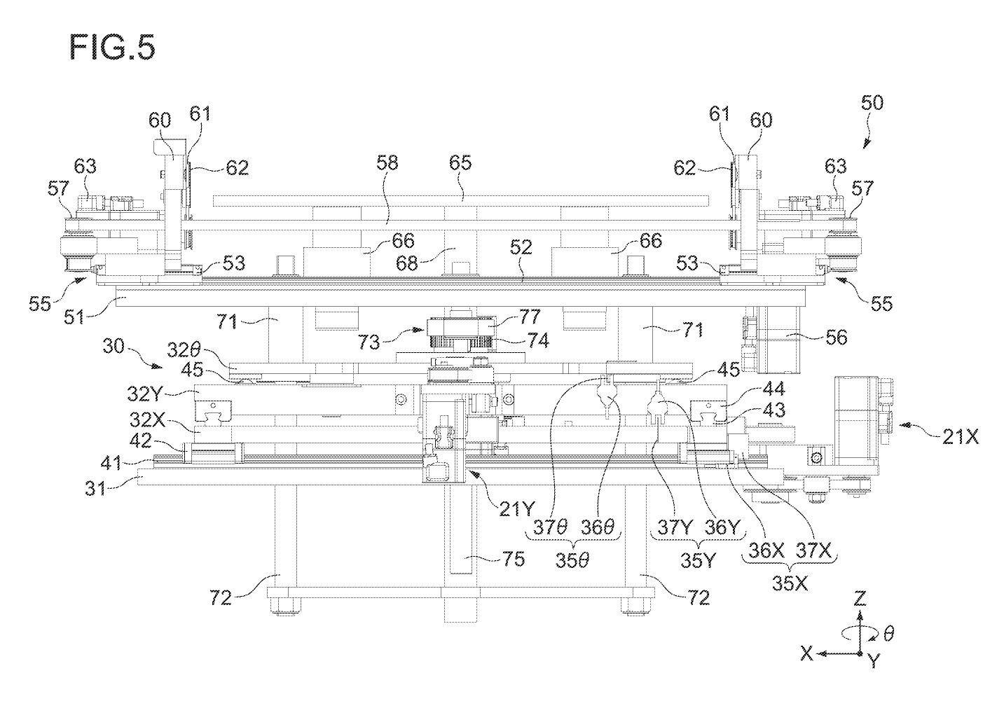

FIG. 3 is a perspective view showing the positioning mechanism 20. FIG. 4 is a side view of the positioning mechanism 20 as viewed from the A direction shown in FIG. 3, and FIG. 5 is a side view of the positioning mechanism 20 as viewed from the B direction shown in FIG. 3.

As shown in FIGS. 3 to 5, the positioning mechanism 20 includes a table mechanism 30 for positioning the substrate 9 and a substrate holding mechanism 50 that is provided on the table mechanism 30 and holds the substrate 9.

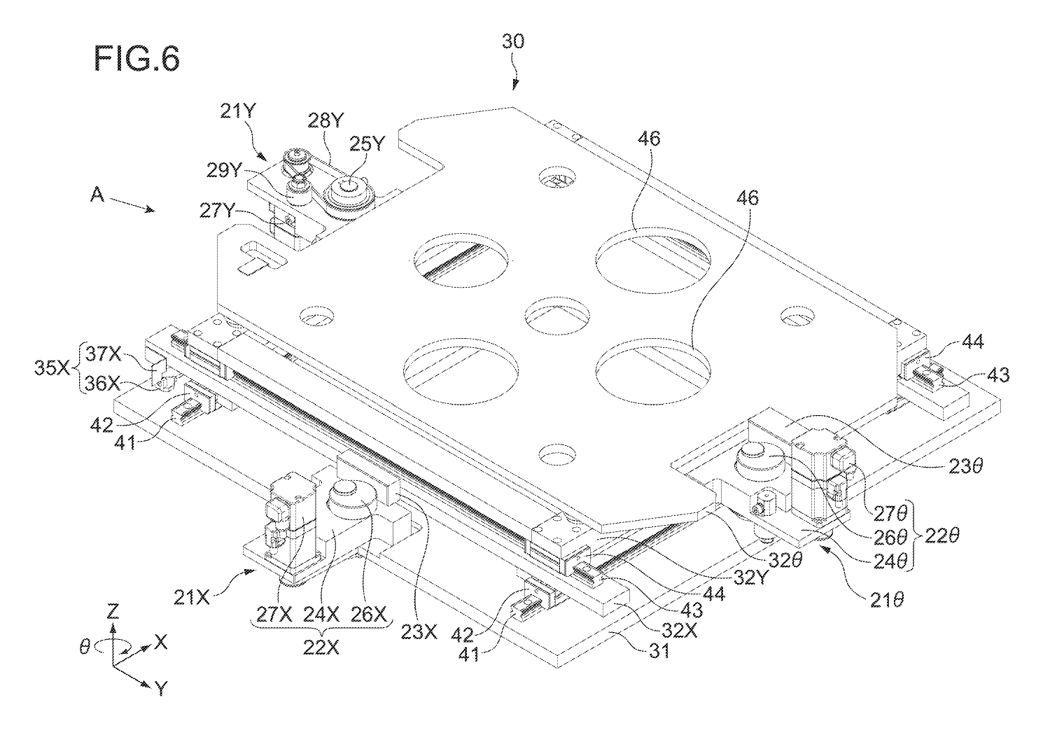

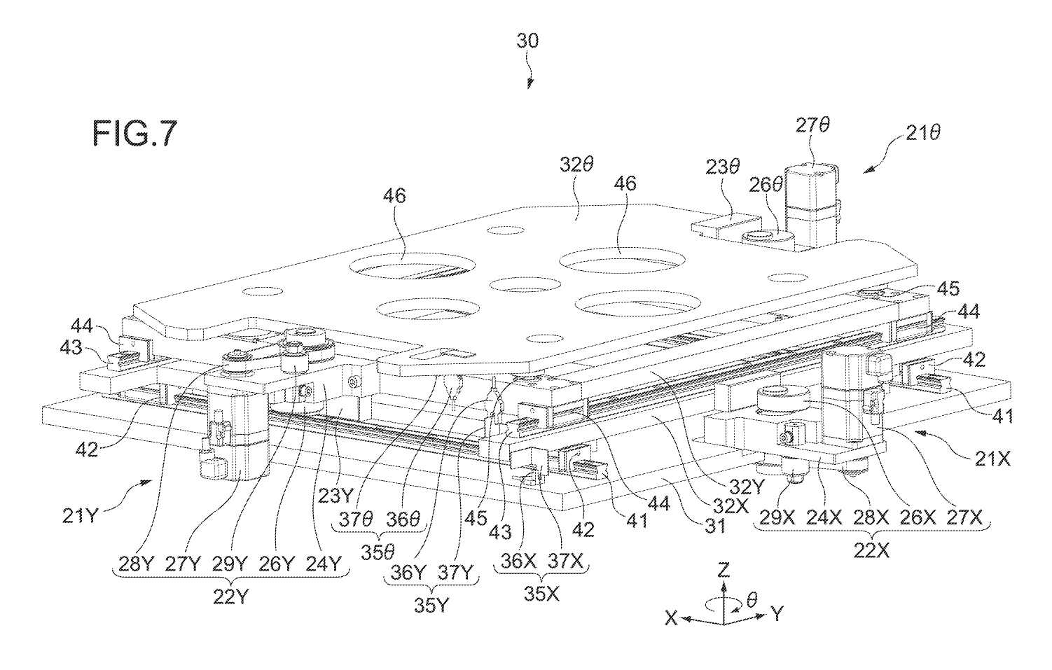

FIG. 6 is a perspective view showing the table mechanism 30. FIG. 7 is a perspective view of the table mechanism 30 as viewed from the A direction shown in FIG. 6.

(Structure of Table Mechanism 30)

The structure of the table mechanism 30 will first be described with reference to FIGS. 6 and 7.

The table mechanism 30 includes a base 31, a frame-like X-axis table 32X provided on the base 31, a frame-like Y-axis table 32Y provided on the X-axis table 32X, and a θ-axis table 32θ provided on the Y-axis table 32Y. Further, the table mechanism 30 includes an X-axis eccentric cam mechanism 21X that moves the X-axis table 32X, a Y-axis eccentric cam mechanism 21Y that moves the Y-axis table 32Y, and a θ-axis eccentric cam mechanism 21θ that rotates (moves) the θ-axis table 32θ. The X-, Y-, and θ-axis eccentric cam mechanisms 21 each have the same structure.

Two guide rails 41 are provided on the base 31 along the X-axis direction. The X-axis table 32X is provided on slide members 42 that are provided on the two guide rails 41 so as to be slidable. Two guide rails 43 are provided on the X-axis table 32X along the Y-axis direction. The Y-axis table 32Y is provided on slide members 44 that are provided on the two guide rails 43 so as to be slidable.

On the Y-axis table 32Y, hemispherical support members 45 are provided in the vicinity of the four corners thereof (see FIGS. 4 and 5). Those four support members 45 support the rotation of the θ-axis table 32θ.

The θ-axis table 32θ is provided with a plurality of holes 46. The plurality of holes 46 are used for attaching an up-and-down mechanism that moves up and down the substrate holding mechanism 50 and for passing a suction tube 68 therethrough.

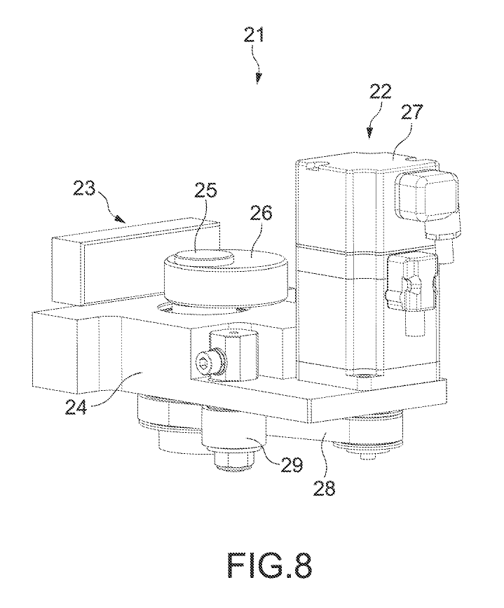

FIG. 8 is a perspective view showing the eccentric cam mechanism 21. As shown in FIG. 8, the eccentric cam mechanism 21 includes an eccentric cam mechanism main body 22 and a cam bearing block 23. The eccentric cam mechanism main body 22 includes a base unit 24, a shaft body 25 that is pivotally supported by the base unit 24 so as to be rotatable, an eccentric cam 26 that is fixed to one end portion of the shaft body 25 and moves the table 32 by a rotation, and a cam drive motor 27 attached to the base unit 24. Further, the eccentric cam mechanism main body 22 includes a timing belt 28 that is extended between an output axis of the cam drive motor 27 and the other end portion of the shaft body 25, and a rotor 29 for adjusting a tension of the timing belt 28.

The eccentric cam 26 is formed of a magnetic body made of iron, cobalt, nickel, or the like. The eccentric cam 26 does not have a complicated shape in which a cam curve and the like are taken into consideration, and has a simple cylindrical shape.

The cam bearing block 23 has a magnet therein. It should be noted that the cam bearing block 23 may be formed of a magnet as a whole.

Since the eccentric cam 26 is formed of a magnetic body and the cam bearing block 23 is formed of a magnet as described above, the eccentric cam 26 and the cam bearing block 23 are attracted to each other by a magnetic force. Therefore, the table 32 moved in one direction by the rotation of the eccentric cam 26 is returned in the opposite direction.

In the case where the table 32 is moved by the rotation of the eccentric cam 26, a return mechanism for returning the table 32, which has been pushed by the eccentric cam 26 once, to the opposite direction is necessary. As the return mechanism, a force by which the magnetic body and the magnet are attracted to each other is utilized in this embodiment.

Referring back to FIGS. 6 and 7, the X-axis eccentric cam mechanism main body 22X is attached to the base 31 in the vicinity of an edge portion of the base 31. On the other hand, the X-axis cam bearing block 23X is attached onto a side surface of the X-axis table 32X. When the X-axis eccentric cam 26X is rotated by the drive of the cam drive motor 27X, the X-axis cam bearing block 23X is moved while following the rotation of the X-axis eccentric cam 26X so that the X-axis table 32X is moved in the X-axis direction. In the case where the X-axis table 32X is moved in the X-axis direction, the Y-axis table 32Y provided on the X-axis table 32X, the θ-axis table 32θ, and the substrate holding mechanism 50 are integrally moved in the X-axis direction.

The Y-axis eccentric cam mechanism main body 22Y is attached upside down onto a side surface of the Y-axis table 32Y. On the other hand, the Y-axis cam bearing block 23Y is attached to a side surface of the X-axis table 32X. When the Y-axis eccentric cam 26Y is rotated by the drive of the cam drive motor 27Y, the Y-axis table 32Y on the side to which the Y-axis eccentric cam mechanism main body 22Y is attached is moved in the Y-axis direction in accordance with the rotation of the Y-axis eccentric cam 26Y. In the case where the Y-axis table 32Y is moved in the Y-axis direction, the θ-axis table 32θ provided on the Y-axis table 32Y and the substrate holding mechanism 50 are integrally moved in the Y-axis direction.

The θ-axis eccentric cam mechanism main body 22θ is attached to a side surface of the Y-axis table 32Y. Specifically, the eccentric cam mechanism main body 22Y of the Y-axis eccentric cam mechanism 21Y and the eccentric cam mechanism main body 22θ of the θ-axis eccentric cam mechanism 21θ are attached to the same table 32 (Y-axis table 32Y). On the other hand, the θ-axis cam bearing block 230 is attached to the θ-axis table 32θ. When the θ-axis eccentric cam 26θ is rotated by the drive of the cam drive motor 27θ, the θ-axis cam bearing block 230 is moved while following the rotation of the θ-axis eccentric cam 26θ so that the θ-axis table 32θ is rotated about an Z axis. In the case where the θ-axis table 32θ is rotated about the Z axis, the substrate holding mechanism 50 provided on the θ-axis table 32θ is rotated integrally with the θ-axis table 32θ.

In the screen printing apparatus 100 according to this embodiment, the eccentric cam mechanism 21 including the eccentric cam 26 is used as a mechanism for driving the table 32. Therefore, as compared to a drive mechanism for a table 32 using a ball screw and the like, costs are reduced.

Further, in this embodiment, since a system using a magnet is adopted as a return mechanism for returning the table 32, which has been pushed by the eccentric cam 26 once, to the opposite direction, it is advantageous in terms of reduction in costs and size. On the other hand, for example, a system using a spring, an air cylinder, or the like may be adopted as the return mechanism, instead of the system using a magnet.

For example, regarding the X-axis table 32X, a spring member that attracts the X-axis table 32X toward the side on which the X-axis eccentric cam mechanism main body 22X is provided is provided to the X-axis eccentric cam mechanism 21X. Alternatively, an air cylinder (or spring member) that presses the X-axis table 32X to the side on which the X-axis eccentric cam mechanism main body 22X is provided is provided on the other side of the X-axis table 32X, which is the opposite position of the X-axis eccentric cam mechanism main body 22X. It should be noted that the system using the magnet described above is particularly effective in terms of the reduction in cost and size.

Further, in this embodiment, in the case where the eccentric cam mechanism 21 is used, the eccentric cam mechanism 21 is allowed to be arranged on the outer side of the table 32, which leads to easy maintenance. Further, in the case where the eccentric cam mechanism 21 is used, the components of the eccentric cam mechanisms 21 of the respective axes are easily standardized.

Further, since the eccentric cam 26 is set to have a rotation range of about ±90 degrees at a maximum from the center of the cam stroke, the eccentric cam 26 is capable of operating at a low rotation speed. Therefore, the cam drive motor 27 that has a wide selection range and is inexpensive is also used.

Further, as in this embodiment, in the case where the eccentric cam mechanism 21 is used, the table 32 is moved within the rotation range of the eccentric cam 26, and its movable range is thus small. Therefore, it is unnecessary to provide a regulation mechanism for regulating the operation of the table 32 when the cam drive motor 27 goes out of control, a sensor that detects an excessive operation of the table 32, and the like. Also from such a perspective, it is found that the reduction in costs is achieved in this embodiment.

In the example shown in FIGS. 6, 7, and others, regarding the Y-axis eccentric cam mechanism 21Y, the eccentric cam mechanism main body 22Y is attached upside down to the Y-axis table 32Y and the cam bearing block 23Y is attached to the X-axis table 32X, or may be vice versa. Specifically, the eccentric cam mechanism main body 22Y may be attached (not upside down) to the X-axis table 32X and the cam bearing block 23Y may be attached to the Y-axis table 32Y.

In this case, however, the Y-axis eccentric cam mechanism main body 22Y and the θ-axis eccentric cam mechanism main body 22θ are attached to the different tables 32. In this case, the Y-axis eccentric cam mechanism main body 22Y and the θ-axis eccentric cam mechanism main body 22θ are operated individually. In this situation, since a power-supply cable connected to the Y-axis cam drive motor 27Y and a power-supply cable connected to the θ-axis cam drive motor 27θ are differently moved, there is a possibility that those cables may be roughly handled.

On the other hand, in the case where the Y-axis eccentric cam mechanism main body 22Y is attached upside down to the Y-axis table 32Y and the cam bearing block 23Y is attached to the X-axis table 32X, the Y-axis eccentric cam mechanism main body 22Y and the θ-axis eccentric cam mechanism main body 22θ are attached to the same table 32 (Y-axis table 32Y). In this case, the power-supply cable connected to the Y-axis cam drive motor 27Y and the power-supply cable connected to the θ-axis cam drive motor 27θ are similarly moved. Therefore, those cables are prevented from being roughly handled.

With reference to FIG. 7 (refer to also FIG. 5), the table mechanism 30 includes sensor units 35 for detecting a temporary center of a cam stroke of the eccentric cam 26 (roughly-set center of cam stroke) for each of the X-axis eccentric cam mechanism 21X, the Y-axis eccentric cam mechanism 21Y, and the θ-axis eccentric cam mechanism 21θ.

The sensor unit 35X that detects a temporary center of a cam stroke of the X-axis eccentric cam 26X includes a photodetector 36X attached to the base 31 and a plate member 37X for detecting the sensor attached to the X-axis table 32X. The sensor unit 35Y that detects a temporary center of a cam stroke of the Y-axis eccentric cam 26Y includes a photodetector 36Y attached to the Y-axis table 32Y and a plate member 37Y for detecting a sensor attached to the X-axis table 32X. The sensor unit 35θ that detects a temporary center of a cam stroke of the θ-axis eccentric cam 26θ includes a photodetector 360 attached to the Y-axis table 32Y and a plate member 37θ attached to the θ-axis table 32θ.

A position where the photodetector 36 is attached and a position where the plate member 37 is attached may be reversed. For example, regarding the X axis, the photodetector 36X may be attached to the X-axis table 32X, and the plate member 37X may be attached to the base 31.

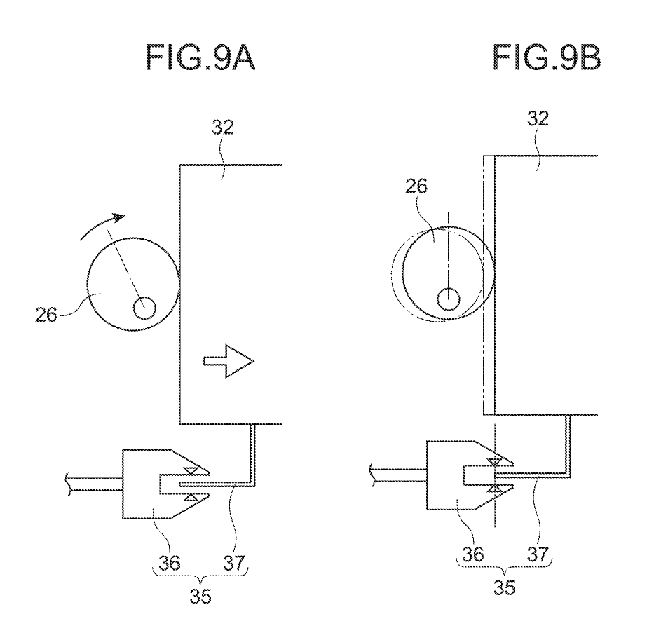

FIGS. 9A and 9B are schematic diagrams each showing a relationship between the movement of the eccentric cam 26 and the sensor unit 35. As shown in FIG. 9A, when the table 32 is moved by the rotation of the eccentric cam 26, the plate member 37 attached to the table 32 is moved. Then, when the eccentric cam 26 rotates up to a position shown in FIG. 9B, a light-receiving state of the photodetector 36 and a non-light-receiving state thereof are switched. Thus, a temporary center of a cam stroke of the eccentric cam 26 is detected. The position of the eccentric cam 26 shown in FIG. 9B is the temporary center of the cam stroke of the eccentric cam 26.

(Structure of Substrate Holding Mechanism 50)

Next, the structure of the substrate holding mechanism 50 will be described with reference to FIGS. 3 to 5. As shown in FIGS. 3 to 5, the substrate holding mechanism 50 includes a base 51 disposed on the θ-axis table 32θ, two belt holding members 60 disposed on the base 51, and a stage support member 65 disposed on the base 51. The two belt holding members 60 are disposed along the Y-axis direction and hold conveyer belts 61 that convey the substrate 9. The stage support member 65 supports the substrate suction stage (not shown) that sucks and holds the substrate 9 from below.

On the θ-axis table 32θ, four Z-axis guides 71 are fixed, and the base 51 is disposed on those four Z-axis guides 71. It should be noted that the base 51 is not fixed to the Z-axis guides 71. Four shafts 72 that extend downward of the base 51 and are guided by the Z-axis guides 71 are fixed to the base 51.

At the center of the θ-axis table 32θ, a rotary ball screw 73 is provided. The rotary ball screw 73 includes a ball screw nut 74 and a ball screw 75. The ball screw nut 74 is provided above the center of the θ-axis table 32θ so as to be rotatable about the Z axis. The ball screw 75 moves vertically in accordance with the rotation of the ball screw nut 74. The upper end portion of the ball screw 75 is in contact with the lower surface of the base 51.

A motor 76 as a drive source of the rotary ball screw 73 is attached to the lower side of the θ-axis table 32θ.

An output axis of the motor 76 is disposed above the θ-axis table 32θ, and a belt 77 is extended between the output axis and the ball screw nut 74. Thus, when the motor 76 is driven, the belt 77 transmits the drive of the motor 76 to the ball screw nut 74 to rotate the ball screw nut 74 so that the ball screw 75 moves vertically in accordance with the rotation of the ball screw nut 74. When the ball screw 75 moves vertically, the four shafts 72 provided on the lower side of the base 51 are guided by the four Z-axis guides 71 provided on the upper side of the θ-axis table 32θ, and simultaneously the base 51 is moved vertically with respect to the θ-axis table 32θ. Thus, the substrate holding mechanism 50 is moved vertically with respect to the table mechanism 30.

Two guide rails 52 are disposed on the base 51 along the X-axis direction. Two slide members 53 that slide on the guide rails 52 are provided on those two guide rails 52. The belt holding members 60 are attached above the slide member 53 capable of sliding one of the guide rails 52 and the slide member 53 capable of sliding the other guide rail 52. Thus, the two belt holding members 60 are movable along the X-axis direction.

A width adjustment mechanism 55 for adjusting the width between the two belt holding members 60 in the X-axis direction is provided on the base 51 at outward positions of the two belt holding members 60 in the X-axis direction. A width adjustment motor 56 as a drive source of the width adjustment mechanism 55 is attached to the lower side of the base 51. A plurality of pulleys 57 and a plurality of belts 58 are provided on the base 51 along the edge portions of the base 51. The plurality of pulleys 57 and the plurality of belts 58 transmit the drive of the width adjustment motor 56 to the width adjustment mechanism 55. The width adjustment mechanism 55 adjusts a distance between the two belt holding members 60 in accordance with the width of the substrate 9.

A plurality of pulleys 62 are provided so as to be rotatable on the inner surface side of the belt holding members 60. Conveyer belts 61 elongated in the Y-axis direction are extended between the plurality of pulleys 62. Conveyer drive motors 63 are attached to outer surfaces of the belt holding members 60, and the conveyer belt 61 is extended between the output axes of the conveyer drive motors 63. The drive of the conveyer drive motors 63 rotate the conveyer belts 61, thus conveying the substrate 9 placed on the conveyer belts 61.

Four cylindrical support members 66 are provided on the base 51. On those four support members 66, the stage support member 65 that supports the substrate suction stage (not shown) from below is provided. The substrate suction stage sucks and holds the substrate 9. Those four support members 66 are structured to be capable of adjusting the height of the stage support member 65 with respect to the base 51. In the vicinity of the center of the stage support member 65, a hole 67 that vertically passes therethrough is provided. The suction tube 68 is connected to the hole 67. The suction tube 68 is connected to an air compressor or the like (not shown). The drive of the air compressor allows the substrate 9 to be sucked and held by the substrate suction stage, thus preventing the misalignment of the substrate 9.

The reference mark 8 (see FIG. 12) imaged by the imaging unit 85 in a calibration sequence to be described later is provided on the substrate suction stage, the stage support member 65, the base 51 of the substrate holding mechanism 50, or the belt holding member 60. The reference mark 8 may be especially provided on the above-mentioned members, or a shape of the hole already provided on the member or the like may be used as the reference mark 8. The position to be provided with the reference mark 8 is typically provided on a member that is moved along with the drive of the table mechanism 30. Additionally, the reference mark 8 may be provided in any position as long as the reference mark 8 can be imaged with the imaging unit 85.

[Description on Operation]

Next, the processing of the screen printing apparatus 100 according to this embodiment will be described.

(Calibration Sequence)

First, processing in a calibration sequence will be described. In the processing, a difference between a command value of the movement of the table 32 by a controller and an actual movement value of the table 32, which results from variations due to individual differences between the eccentric cams 26, is determined by image processing. This calibration sequence is, for example, executed at the shipment of the screen printing apparatus 100 or at the maintenance of the screen printing apparatus 100.

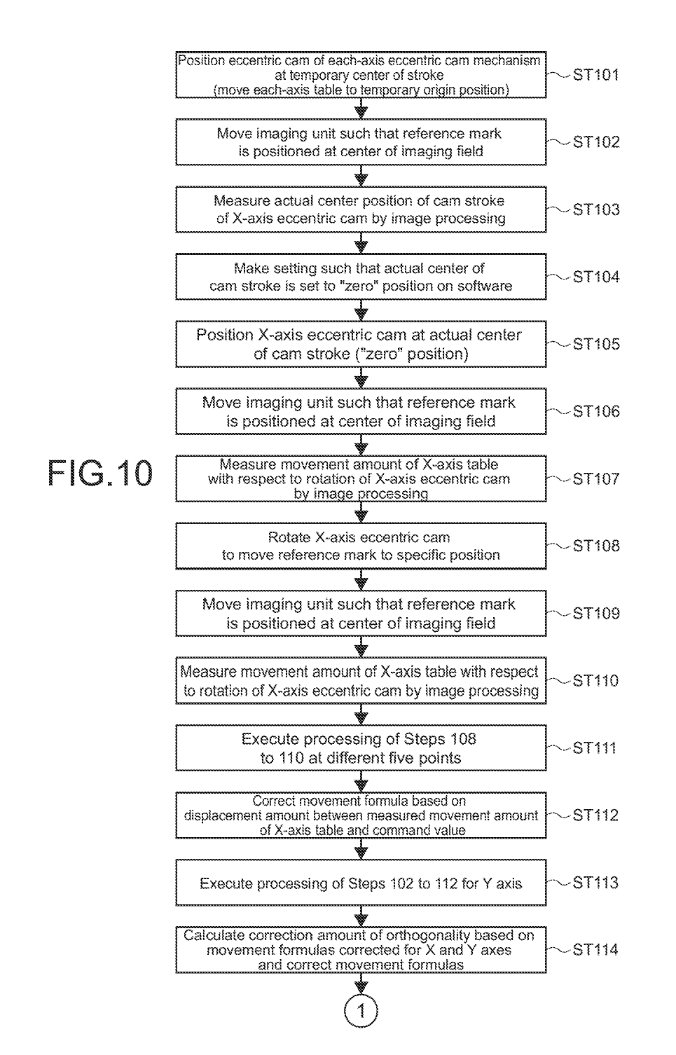

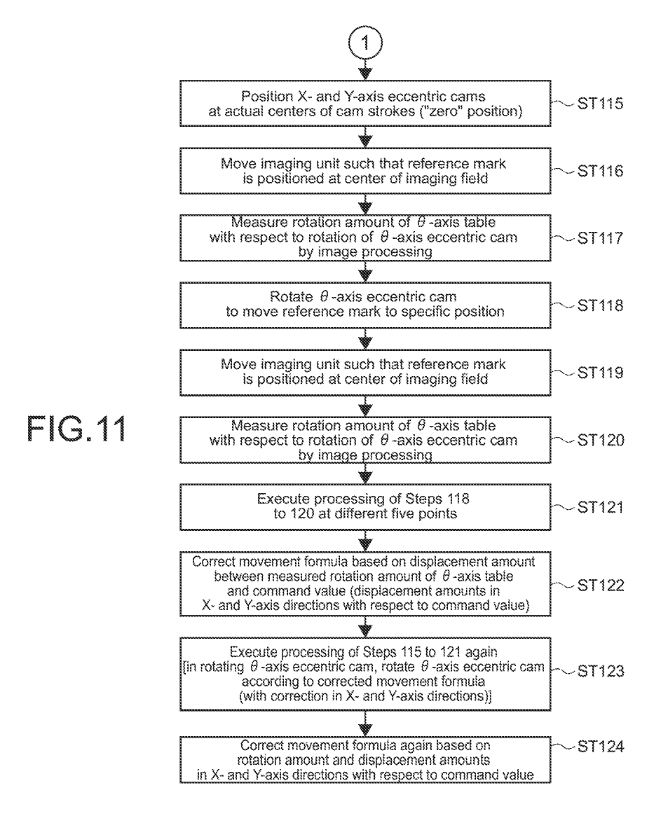

FIGS. 10 and 11 are flowchart of the processing of the screen printing apparatus 100 in a calibration sequence. First, the controller causes each of the eccentric cams 26 of the X-, Y-, and θ-axis eccentric cam mechanisms 21 to be located at a temporary center of a cam stroke thereof (roughly-set center of cam stroke) (Step 101) (see FIG. 9).

In this case, first, the controller drives the cam drive motor 27 of the eccentric cam mechanism 21 of each corresponding axis to rotate the eccentric cam 26 of each corresponding axis. When the eccentric cam 26 is rotated, the cam bearing block 23 is moved while following the rotation of the eccentric cam 26 (in the Y-axis eccentric cam mechanism 21Y, the Y-axis eccentric cam 26Y side is moved), to thereby move the table 32 of each corresponding axis. When the table 32 of the corresponding axis is moved, relative positions of the photodetector 36 and the plate member 37 for detecting a sensor, which are included in the sensor unit 35, are changed so that the light-receiving state and the non-light-receiving state of the photodetector 36 are switched at a specific position.

The controller stops the drive of the cam drive motor 27 at a position where the light-receiving state and the non-light-receiving state of the photodetector 36 are switched. Thus, the eccentric cam 26 of the eccentric cam mechanism 21 of each corresponding axis is located at the temporary center of the cam stroke thereof. Then, the table 32 of each corresponding axis is moved to a temporary origin position.

By such processing, even if the controller does not yet recognize an actual center of the cam stroke (for example, at a time of power-on), the controller recognizes an approximate center of the cam stroke of the eccentric cam 26.

Next, the controller moves the first imaging unit 86, i.e., the camera directed toward the lower side, by the movement mechanism of the imaging unit 85 such that the reference mark 8 is located at the center of an imaging field of the first imaging unit 86 (Step 102). In this case, the controller moves the imaging unit 85 such that the reference mark 8 is located at the center of the imaging field based on information of an image including the reference mark 8 acquired by the first imaging unit 86. FIG. 12 shows a state where the reference mark 8 is located at the center of the imaging field.

Next, the controller measures an actual center of the cam stroke of the X-axis eccentric cam 26X based on the image including the reference mark 8 acquired by the first imaging unit 86 (Step 103). In this case, the controller first drives the cam drive motor 27X of the X-axis eccentric cam mechanism 21X and rotates the X-axis eccentric cam 26X located at the temporary center of the cam stroke thereof, to thereby move the X-axis table 32X. Along with the movement of the X-axis table 32X, the reference mark 8 is moved within the imaging field of the first imaging unit 86. The controller measures an actual center of the cam stroke of the X-axis eccentric cam 26X based on the image of the reference mark 8 that is moved within the imaging field.

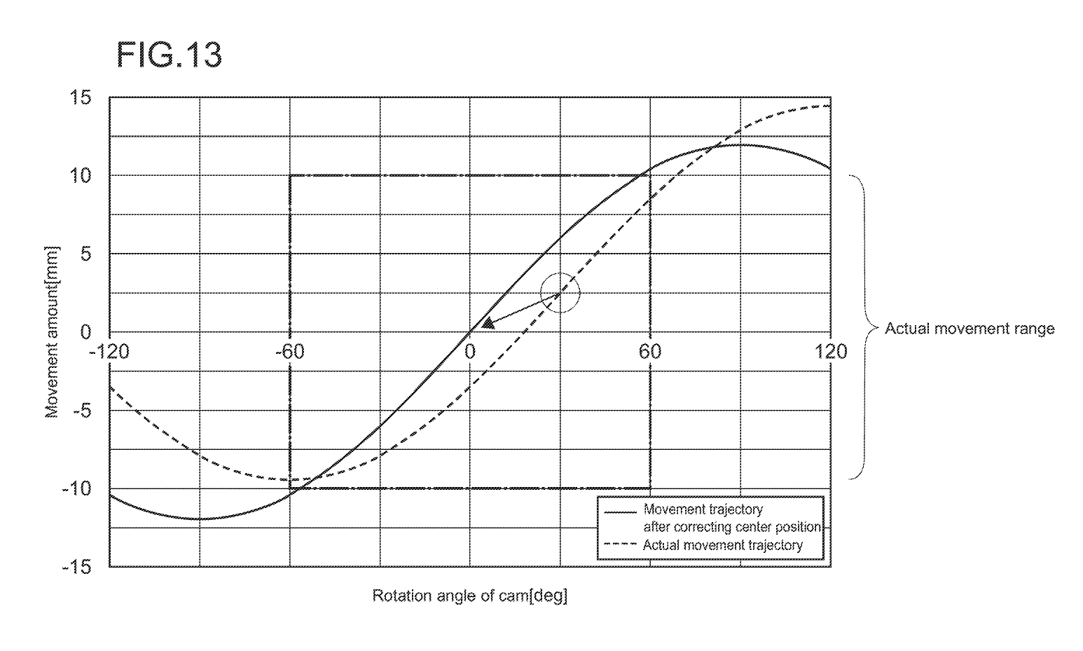

FIG. 13 is a graph showing a relationship between a trajectory of an actually-measured movement amount of the table 32 (movement amount of reference mark 8) with respect to the rotation of the eccentric cam 26 and a trajectory of the movement amount of the table 32 (movement amount of reference mark 8) with respect to the eccentric cam 26, the movement amount being obtained after correcting a center position to be described later.

As indicated by a dotted line in FIG. 13, the movement amount of the table 32 (movement amount of reference mark 8) depicts a sinusoidal trajectory with respect to the rotation of the eccentric cam 26. The origin position of the sinusoidal trajectory corresponds to the actual center of the cam stroke. The controller measures a position of the actual center of the cam stroke based on the image captured by the first imaging unit 86.

As described above, in this embodiment, the reference mark 8 is set to the center of the imaging field of the first imaging unit 86, and then the eccentric cam 26 is rotated to move the reference mark 8 within the imaging field, with the result that an influence caused by a lens distortion of the imaging unit 85 is eliminated. Thus, the trajectory of the movement amount of the table 32 with respect to the rotation of the eccentric cam 26 is precisely measured, and accordingly the actual center of the cam stroke is precisely measured.

Next, the controller makes a setting such that the measured actual center of the cam stroke is set to a zero position on software (Step 104). FIG. 13 shows a state where this setting is executed.

Next, the controller drives the cam drive motor 27X of the X-axis eccentric cam mechanism 21X to rotate the X-axis eccentric cam 26X such that the X-axis eccentric cam 26X is positioned at the actual center of the cam stroke thereof (zero position) (Step 105).

Next, in the state where the X-axis eccentric cam 26X is located at the actual center of the cam stroke thereof, the controller moves the first imaging unit 86 such that the reference mark 8 is positioned at the center of the imaging field of the first imaging unit 86 (Step 106).

Then, the controller measures the movement amount of the X-axis table 32X with respect to the rotation of the X-axis eccentric cam 26X based on the image including the reference mark 8 acquired by the first imaging unit 86 (Step 107). In this case, the controller first drives the cam drive motor 27X of the X-axis eccentric cam mechanism 21X and rotates the X-axis eccentric cam 26X located at the actual center of the cam stroke thereof, to thereby move the X-axis table 32X. In accordance with the movement of the X-axis table 32X, the reference mark 8 moves within the imaging field of the first imaging unit 86. The controller measures the movement amount of the X-axis table 32X with respect to the rotation of the X-axis eccentric cam 26X based on the image of the reference mark 8 that moves within the imaging field.

As described above, in this embodiment, the eccentric cam 26 is rotated from a position corresponding to the actual center of the cam stroke, and based on the image of the reference mark 8 that moves within the imaging field in accordance with the movement of the eccentric cam 26, the movement amount of the table 32 with respect to the rotation of the eccentric cam 26 is measured. Thus, the movement amount of the table 32 with respect to the rotation of the eccentric cam 26 is precisely measured.

In addition, since the reference mark 8 is located at the center of the imaging field of the first imaging unit 86 and then the eccentric cam 26 is rotated to move the reference mark 8 with the imaging field, the influence caused by the lens distortion of the imaging unit 85 is eliminated. Thus, the movement amount of the table 32 with respect to the rotation of the eccentric cam 26 is more precisely measured. The same effect is also obtained for the Y axis and the θ axis to be described later.

Next, the controller rotates the X-axis eccentric cam 26X by a predetermined rotation amount from the actual center of the cam stroke and moves the reference mark 8 to a specific position (Step 108). Then, the controller moves the first imaging unit 86 by the movement mechanism of the imaging unit 85 such that the reference mark 8 is positioned at the center of the imaging field of the first imaging unit 86 (Step 109). Thus, the influence caused by the lens distortion of the imaging unit 85 is eliminated.

Next, the controller measures the movement amount of the X-axis table 32X with respect to the rotation of the X-axis eccentric cam 26X based on the image including the reference mark 8 acquired by the first imaging unit 86 (Step 110). In Step 110, the controller first drives the cam drive motor 27X of the X-axis eccentric cam mechanism 21X and rotates the X-axis eccentric cam 26X, to thereby move the X-axis table 32X. The controller measures the movement amount of the X-axis table 32X with respect to the rotation of the X-axis eccentric cam 26X based on the image of the reference mark 8 that moves within the imaging field of the first imaging unit 86 in accordance with the movement of the X-axis table 32X.

The controller executes the processing of Steps 108 to 110 at different five points (Step 111).

Next, the controller calculates a displacement amount between the movement amount of the X-axis table 32X with respect to the rotation of the X-axis eccentric cam 26X, which is obtained by the measurement, and the command value for moving the X-axis table 32X, which is held by the controller. Then, the controller corrects, based on the calculated displacement amount, a movement formula used for moving the X-axis table 32X (Step 112).

Next, the controller executes the processing of Steps 102 to 112 for the Y-axis eccentric cam mechanism 21Y and the Y-axis table 32Y (Step 113).

Then, based on the movement formulas corrected for the X axis and the Y axis, the controller calculates a correction amount of orthogonality and revises the movement formulas for moving the X-axis table 32X and the Y-axis table 32Y based on the correction amount of orthogonality (Step 114). Thus, the movement formula used for moving the X-axis table 32X and the movement formula used for moving the Y-axis table 32Y are precisely corrected.

Next, the controller drives the X- and Y-axis cam drive motors 27X and 27Y to move the X-axis eccentric cam 26X and the Y-axis eccentric cam 26Y to the respective actual centers of the cam strokes (zero position) (Step 115). Then, in the state where the X-axis eccentric cam 26X and the Y-axis eccentric cam 26Y are located at the actual centers of the cam strokes, the controller moves the first imaging unit 86 such that the reference mark 8 is located at the center of the imaging field of the first imaging unit 86 (Step 116).

Next, the controller measures a rotation amount of the θ-axis table 32θ with respect to the rotation of the θ-axis eccentric cam 26θ based on the image including the reference mark 8 acquired by the first imaging unit 86 (Step 117). In Step 117, the controller first drives the θ-axis cam drive motor 27θ and rotates the θ-axis eccentric cam 26θ, to thereby rotate the θ-axis table 32θ. The controller measures the rotation amount of the θ-axis table 32θ with respect to the rotation of the θ-axis eccentric cam 26θ based on the image of the reference mark 8 that moves within the imaging field of the first imaging unit 86 in accordance with the rotation of the θ-axis table 32θ.

Next, the controller rotates the θ-axis eccentric cam 26θ by a predetermined rotation amount and moves the reference mark 8 to a specific position (Step 118). Then, the controller moves the first imaging unit 86 such that the reference mark 8 is located at the center of the imaging field of the first imaging unit 86 (Step 119).

Next, the controller measures the rotation amount of the θ-axis table 32θ with respect to the rotation of the θ-axis eccentric cam 26θ based on the image including the reference mark 8 acquired by the first imaging unit 86 (Step 120). In this case, the controller drives the cam drive motor 27 of the θ-axis eccentric cam mechanism 21θ and rotates the θ-axis eccentric cam 26θ, to thereby rotate the θ-axis table 32θ. The controller measures the rotation amount of the θ-axis table 32θ with respect to the rotation of the θ-axis eccentric cam 26θ based on the image including the reference mark 8 that moves within the imaging field of the first imaging unit 86 in accordance with the rotation of the θ-axis table 32θ.

The controller executes the processing of Steps 118 to 120 at different five points (Step 121).

Next, the controller calculates a displacement amount between the rotation amount of the θ-axis table 32θ with respect to the rotation of the θ-axis eccentric cam 26θ, which is obtained by the measurement, and the command value for moving the θ-axis table 32θ, which is held by the controller. Then, the controller corrects, based on the calculated displacement amount, a movement formula used for moving the θ-axis table 32θ (Step 122). At this time, the controller corrects the movement formula used for moving the θ-axis table 32θ also based on the displacement amounts in the X-axis direction and the Y-axis direction of the θ-axis table 32θ with respect to the command values.

Next, the controller executes Steps 115 to 121 again (Step 123). At the rotation of the θ-axis eccentric cam 26θ, the controller rotates the θ-axis eccentric cam 26θ according to the already corrected movement formula (with correction in X-axis direction and Y-axis direction).

Then, the controller corrects again the movement formula used for moving the θ-axis table 32θ based on the rotation amount of the θ-axis table 32θ and the displacement amounts in the X-axis direction and the Y-axis direction with respect to the command value (Step 124). Thus, the movement formula used for moving the θ-axis table 32θ is precisely corrected.

Here, the rotation range of the eccentric cam 26 will be described with reference to FIG. 13. As the rotation range of the eccentric cam 26, a range of ±90 degrees from the center of the cam stroke is available. In this range, a range of ±60 degrees from the center of the cam stroke is used in this embodiment. Thus, a pressure angle of the eccentric cam 26 is reduced.

As described above, since the reference mark 8 that moves in accordance with the rotation of the eccentric cam 26 is imaged by the imaging unit 85 to measure the movement amount of the table 32 with respect to the rotation of the eccentric cam 26 in this embodiment, it is not necessary to make the shape of the eccentric cam 26 complicated. In other words, even if the eccentric cam 26 has a simple shape such as a substantially cylindrical shape (simple shape in which a cam curve and the like are not taken into consideration), the movement amount of the table 32 with respect to the rotation of the eccentric cam 26 is precisely measured. Then, the eccentric cam 26 formed into a substantially cylindrical shape allows the costs to be further reduced.

(Reference Position Registration Sequence and Substrate Positioning Sequence)

Next, a reference position registration sequence and a substrate positioning sequence will be described. The substrate positioning sequence is processing executed in normal production and is processing for positioning the substrate 9 with respect to the screen 1.

Before the substrate positioning sequence, a reference position of the substrate 9 with respect to the position of the screen 1 is registered (reference position registration sequence). In the substrate positioning sequence, for the position of the substrate 9 with respect to the position of the screen 1 registered in the reference position registration sequence, it is determined how much the position of the substrate 9 to be processed at that time is displaced in the X-, Y-, and θ-axis directions. Then, based on the determined displacement amounts, the table mechanism 30 corrects the displacement amounts in the X-, Y-, and θ-axis directions so that the substrate 9 is moved to a correct position with respect to the screen 1.

(Reference Position Registration Sequence)

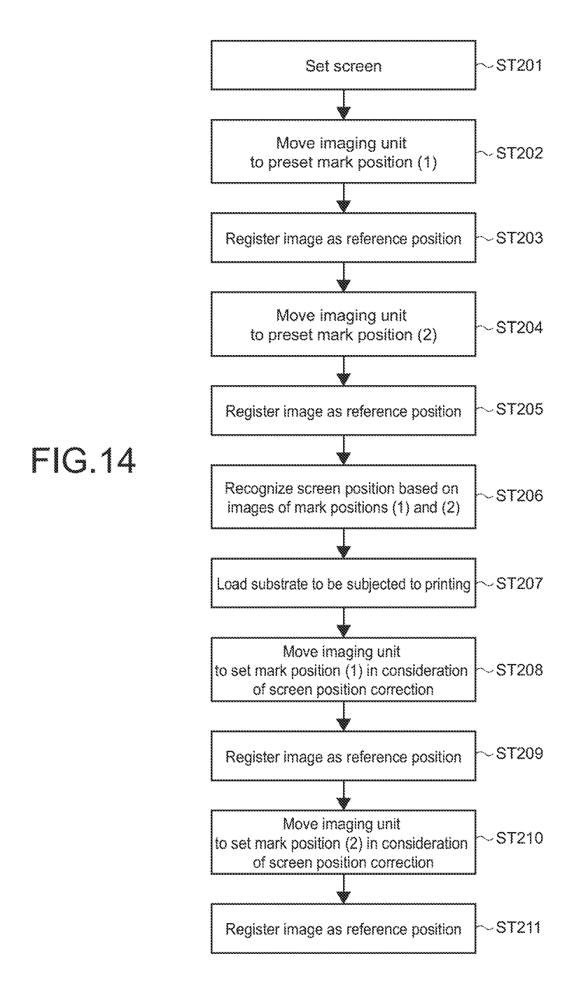

First, processing when the reference position of the substrate 9 with respect to the position of the screen 1 is registered (reference position registration sequence) will be described. FIG. 14 is a flowchart of the reference position registration sequence.

First of all, an operator sets the screen 1 in the screen printing apparatus 100 (Step 201). In this case, the operator sets the screen 1 in the screen printing apparatus 100 with the frame body 2 being vertically sandwiched by the screen clamps 7. The frame body 2 is provided to the four sides of the screen 1 and pulls the screen 1 from the four directions.

The controller controls the movement mechanism of the imaging unit 85 to move the imaging unit 85 to a preset mark position (1) (Step 202). Then, the controller causes the second imaging unit 87 (camera directed toward the upper side) to image one of two alignment marks provided on the lower surface of the screen 1. The controller registers the obtained image as a reference position (Step 203).

Next, the controller controls the movement mechanism of the imaging unit 85 to move the imaging unit 85 to a preset mark position (2) (Step 204). Then, the controller causes the second imaging unit 87 to image the other one of the two alignment marks provided on the lower surface of the screen 1. After that, the controller registers the obtained image as a reference position (Step 205).

The controller recognizes the position of the screen 1 based on the images of the alignment marks imaged at the mark position (1) and the mark position (2) (Step 206).

Then, the substrate 9 to be subjected to printing is loaded (Step 207). At this time, the controller rotates the conveyer belts 61 by the drive of the conveyer drive motors 63 and conveys the substrate 9 on the conveyer belts 61, to thereby move the substrate 9 at a predetermined position of the conveyer belts 61. Then, the substrate 9 is sucked and held by the substrate suction stage.

Next, the controller moves the imaging unit 85 to the set mark position (1) in consideration of the position correction of the screen 1 (Step 208). Then, the controller causes the first imaging unit 86 (camera directed toward the lower side) to image one of two alignment marks provided on the substrate 9. The controller registers the obtained image as a reference position (Step 209).

Next, the controller moves the imaging unit 85 to the set mark position (2) in consideration of the position correction of the screen 1 (Step 210). Then, the controller causes the first imaging unit 86 to image the other one of the two alignment marks provided on the substrate 9. The controller registers the obtained image as a reference position (Step 211).

(Substrate Positioning Sequence)

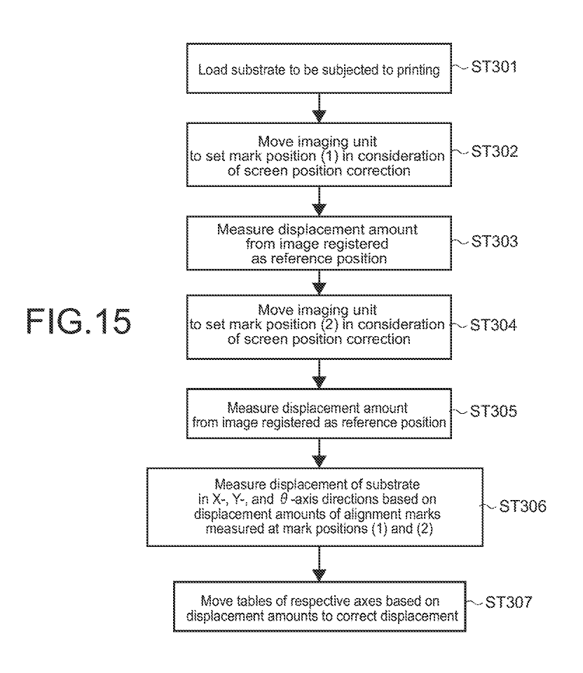

Next, the substrate positioning sequence in which the position of the substrate 9 is aligned with respect to the position of the screen 1 will be described. FIG. 15 is a flowchart of the substrate positioning sequence.

First of all, the substrate 9 to be subjected to printing is loaded (Step 301). Then, the controller moves the imaging unit 85 to the set mark position (1) in consideration of the position correction of the screen 1 (Step 302). Then, the controller causes the first imaging unit 86 to image one of the two alignment marks provided on the substrate 9.

Next, the controller measures a displacement amount between the position of the alignment mark within the image registered as a reference position and the position of the alignment mark within the obtained image (Step 303).

Next, the controller moves the imaging unit 85 to the set mark position (2) in consideration of the position correction of the screen 1 (Step 304). Then, the controller causes the first imaging unit 86 to image the other one of the two alignment marks provided on the substrate 9.

Next, the controller measures a displacement amount between the position of the alignment mark within the image registered as a reference position and the position of the alignment mark within the obtained image (Step 305).

Next, the controller determines how much the substrate 9 is displaced from proper positions in the X-, Y-, and θ-axis directions, based on the displacement amounts of the alignment marks measured at the mark position (1) and the mark position (2) (Step 306).

Next, the controller drives the eccentric cam mechanisms 21 of the respective axes based on the determined displacement amounts to move the tables 32 of the respective axes, thus correcting the displacement of the substrate 9 (Step 307). In this embodiment, as described above, the movement amount of the table 32 with respect to the rotation of the eccentric cam 26 is correct, with the result that the displacement of the substrate 9 is precisely corrected.

Here, the substrate processing apparatus such as the screen printing apparatus 100 generally includes the imaging unit 85 for imaging the alignment marks provided on the substrate 9. In this embodiment, the imaging unit 85 (first imaging unit 86) for imaging the alignment marks on the substrate 9 is used as the imaging unit 85 for imaging the reference mark 8. Thus, the existing imaging unit 85 (imaging unit 85 for imaging alignment marks) is used as the imaging unit 85 for imaging a reference mark, with the result that it is not necessary to especially provide the imaging unit 85 for imaging a reference mark to the substrate processing apparatus. Therefore, costs are more reduced.

### Various Modified Examples

In the example described above, the screen printing apparatus 100 has been exemplified as the substrate processing apparatus in which the table mechanism 30 is used. However, the substrate processing apparatus is not limited thereto. Typically, the present disclosure is applicable to any substrate processing apparatus as long as it is a substrate processing apparatus in which the table mechanism 30 for positioning the substrate 9 is used.

This embodiment has been described that all of the X-axis table 32X, the Y-axis table 32Y, and the θ-axis table 32θ are driven by the drive of the eccentric cam mechanisms 21. However, one or two of the three tables 32 may be driven by the drive of the eccentric cam mechanisms and the other table(s) 32 may be driven by, for example, a ball screw mechanism.

The present disclosure may take the following structures.

(1) A substrate processing apparatus, including:

a table for positioning a substrate;

an eccentric cam mechanism including an eccentric cam configured to move the table by a rotation;

a reference mark that moves in accordance with a movement of the table;

an imaging unit configured to image the reference mark; and

a controller configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

(2) The substrate processing apparatus according to (1), further including a sensor configured to detect a temporary center of a cam stroke of the eccentric cam, in which

the controller rotates the eccentric cam from a state where the eccentric cam is located at the temporary center of the cam stroke and images a reference mark moving in accordance with the rotation of the eccentric cam by the imaging unit, to thereby measure an actual center of the cam stroke of the eccentric cam.

(3) The substrate processing apparatus according to (2), in which

the controller rotates the eccentric cam from a state where the eccentric cam is located at an actual center of the cam stroke of the eccentric cam and images a reference mark moving in accordance with the rotation of the eccentric cam by the imaging unit, to thereby measure a movement amount of the table with respect to the rotation of the eccentric cam.

(4) The substrate processing apparatus according to (2), further including a movement mechanism for moving the imaging unit, in which

the controller moves, in the state where the eccentric cam is located at the temporary center of the cam stroke, the imaging unit by the movement mechanism such that the reference mark is located at a center of an imaging field of the imaging unit, rotates the eccentric cam after the imaging unit is moved, and images a reference mark moving in accordance with the rotation of the eccentric cam by the imaging unit, to thereby measure the actual center of the cam stroke of the eccentric cam.

(5) The substrate processing apparatus according to (3), further including a movement mechanism for moving the imaging unit, in which

the controller moves, in the state where the eccentric cam is located at the actual center of the cam stroke, the imaging unit by the movement mechanism such that the reference mark is located at a center of an imaging field of the imaging unit, rotates the eccentric cam after the imaging unit is moved, and images a reference mark moving in accordance with the rotation of the eccentric cam by the imaging unit, to thereby measure the movement amount of the table with respect to the rotation of the eccentric cam.

(6) The substrate processing apparatus according to any one of (1) to (5), in which

the eccentric cam mechanism includes
the eccentric cam formed of a magnetic body, and
a cam bearing block including a magnet.

(7) The substrate processing apparatus according to any one of (1) to (6), in which

the substrate includes an alignment mark,

the substrate processing apparatus further including an imaging unit configured to image the alignment mark provided on the substrate, the imaging unit being used as the imaging unit configured to image the reference mark.

(8) The substrate processing apparatus according to any one of (1) to (7), in which

the eccentric cam has a substantially cylindrical shape.

(9) A table mechanism, including:

a table for positioning a substrate;

an eccentric cam mechanism including an eccentric cam configured to move the table by a rotation;

a reference mark that moves in accordance with a movement of the table;

an imaging unit configured to image the reference mark; and

a controller configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

(10) A positioning method, including:

rotating an eccentric cam configured to move by a rotation a table for positioning a substrate to move the table;

imaging, by an imaging unit, a reference mark moving in accordance with the movement of the table to measure a movement amount of the table with respect to the rotation of the eccentric cam; and

rotating the eccentric cam in accordance with the measured movement amount to position the substrate at a time of positioning the substrate.

(11) A program causing a substrate processing apparatus to execute:

rotating an eccentric cam configured to move by a rotation a table for positioning a substrate to move the table;

imaging, by an imaging unit, a reference mark moving in accordance with the movement of the table to measure a movement amount of the table with respect to the rotation of the eccentric cam; and

rotating the eccentric cam in accordance with the measured movement amount to position the substrate at a time of positioning the substrate.

The present disclosure contains subject matter related to that disclosed in Japanese Priority Patent Application JP 2011-239658 filed in the Japan Patent Office on Oct. 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A substrate processing apparatus, comprising:
a table for positioning a substrate;
an eccentric cam mechanism including an eccentric cam configured to move the table by a rotation;
a reference mark that moves in accordance with a movement of the table;
an imaging unit configured to image the reference mark; and
a controller configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

2. The substrate processing apparatus according to claim 1, further comprising a sensor configured to detect a temporary center of a cam stroke of the eccentric cam, wherein
the controller rotates the eccentric cam from a state where the eccentric cam is located at the temporary center of the cam stroke and images a reference mark moving in accordance with the rotation of the eccentric cam by the imaging unit, to thereby measure an actual center of the cam stroke of the eccentric cam.

3. The substrate processing apparatus according to claim 2, wherein
the controller rotates the eccentric cam from a state where the eccentric cam is located at an actual center of the cam stroke of the eccentric cam and images a reference mark moving in accordance with the rotation of the eccentric cam by the imaging unit, to thereby measure a movement amount of the table with respect to the rotation of the eccentric cam.

4. The substrate processing apparatus according to claim 2, further comprising a movement mechanism for moving the imaging unit, wherein
the controller moves, in the state where the eccentric cam is located at the temporary center of the cam stroke, the imaging unit by the movement mechanism such that the reference mark is located at a center of an imaging field of the imaging unit, rotates the eccentric cam after the imaging unit is moved, and images a reference mark moving in accordance with the rotation of the eccentric cam by the imaging unit, to thereby measure the actual center of the cam stroke of the eccentric cam.

5. The substrate processing apparatus according to claim 3, further comprising a movement mechanism for moving the imaging unit, wherein
the controller moves, in the state where the eccentric cam is located at the actual center of the cam stroke, the imaging unit by the movement mechanism such that the reference mark is located at a center of an imaging field of the imaging unit, rotates the eccentric cam after the imaging unit is moved, and images a reference mark moving in accordance with the rotation of the eccentric cam by the imaging unit, to thereby measure the movement amount of the table with respect to the rotation of the eccentric cam.

6. The substrate processing apparatus according to claim 1, wherein
the eccentric cam mechanism includes
the eccentric cam formed of a magnetic body, and
a cam bearing block including a magnet.

7. The substrate processing apparatus according to claim 1, wherein
the substrate includes an alignment mark,
the substrate processing apparatus further comprising an imaging unit configured to image the alignment mark provided on the substrate, the imaging unit being used as the imaging unit configured to image the reference mark.

8. The substrate processing apparatus according to claim 1, wherein
the eccentric cam has a substantially cylindrical shape.

9. A table mechanism, comprising:
a table for positioning a substrate;
an eccentric cam mechanism including an eccentric cam configured to move the table by a rotation;
a reference mark that moves in accordance with a movement of the table;
an imaging unit configured to image the reference mark; and
a controller configured to rotate the eccentric cam to move the table, image the reference mark moving in accordance with the movement of the table by the imaging unit to measure a movement amount of the table with respect to the rotation of the eccentric cam, and rotate the eccentric cam in accordance with the measured movement amount to position the substrate at a time of positioning the substrate.

10. A positioning method, comprising:
rotating an eccentric cam configured to move by a rotation a table for positioning a substrate to move the table;
imaging, by an imaging unit, a reference mark moving in accordance with the movement of the table to measure a movement amount of the table with respect to the rotation of the eccentric cam; and
rotating the eccentric cam in accordance with the measured movement amount to position the substrate at a time of positioning the substrate.

11. A program causing a substrate processing apparatus to execute:
rotating an eccentric cam configured to move by a rotation a table for positioning a substrate to move the table;
imaging, by an imaging unit, a reference mark moving in accordance with the movement of the table to measure a movement amount of the table with respect to the rotation of the eccentric cam; and
rotating the eccentric cam in accordance with the measured movement amount to position the substrate at a time of positioning the substrate.
